(19) United States
(12) Patent Application Publication
(10) Pub. No.: US 2009/0285454 A1
(43) Pub. Date: Nov. 19, 2009

(54) METHOD AND SYSTEM FOR FACIAL RECOGNITION TRAINING OF USERS OF ENTERTAINMENT SYSTEMS

(75) Inventor: Ning Xu, Irvine, CA (US)

Correspondence Address: KNOBBE, MARTENS, OLSON, & BEAR, LLP, 2040 MAIN STREET, FOURTEENTH FLOOR, IRVINE, CA, 92614, US

(73) Assignee: Samsung Electronics Co., Ltd., Suwon-City (KR)

(21) Appl. No.: 12/121,695

(22) Filed: May 15, 2008

(51) Int. Cl. G06K 9/20

(52) U.S. Cl. 382/118

(57) ABSTRACT

An entertainment system that includes an image capture device which captures images of new users and mathematically processes the images so that a matrix of representative images of all known users if formed. The matrix can then be applied to subsequent new images to determine whether a new image of a user is a known user to the system to that preferences associated with the user can be employed in the delivery of entertainment content to the user.

### BACKGROUND OF THE INVENTION

1. Field of the Invention

The present invention relates to entertainment systems, such as television systems, and, in particular, entertainment systems that have face identification systems so as to identify users of the system to thereby permit customization of the content being provided to the identified user.

2. Description of the Related Art

Entertainment systems, such as televisions systems and the like, are becoming increasingly more sophisticated and able to provide a much greater variety of entertainment media to viewers. Cable systems and satellite systems used in conjunction with television sets can provide multiple hundreds of channels to viewers with a huge variety of different programming options. In this context, oftentimes the information that is being provided overwhelms the user, making use of the entertainment device more complicated. It is expected that the amount of entertainment media that is being provided through television sets, computer via the internet and the like, will increase dramatically in the future, further exacerbating the difficulty of individual users have in selecting entertainment media that is interesting to them.

Efforts have been made to attempt to recognize individual users of an entertainment device in order to customize the entertainment media for particular users. One example would be remote control devices used with television sets that can be programmed with particular channels that are appealing to particular users. However, this type of customization is necessarily limited and will become increasingly less effective as more entertainment media options are provided to the users.

It may be advantageous for systems to be able to recognize individual users. In other contexts, systems for recognizing and identifying individuals have been disclosed but, in general, these systems are not readily adaptable to a compact media devices, such as a television set or other entertainment device. One example of the type of processing that is done in order to identify individuals from still or video images is disclosed in a paper entitled “Eigenfaces faces vs. Fisherfaces: Recognition Using Class Specific Linear Projection” by Belhumeur et al., published in the IEEE Transactions on Pattern Analysis and Machine Intelligence, Vol. 19, No. 7, July 1997, which is hereby incorporated in its entirety.

In general, digital images of individuals are mathematically translated into a matrix of digital data that is representative of the significant geographic features of the individual's face. In general, images of individuals are digitized and processed so as to highlight or enhance the contrast between different areas of the individual's face. Certain features and associated pixel location and intensity values thereof can then be used as monuments and the distance or relative position between monuments can be used for identification purposes. Various mathematical operations can be performed on the face data so as to generate easier to process mathematical representations of individual faces. It will be appreciated that for many face identification applications, the subsequently captured image data has to be compared to a large library of previously stored face image data which can significantly complicate the identification analysis. Generally, in these systems, each individual is determined to be a particular class of data which complicates the identification process as new individuals have to be compared to each class. Further, existing technologies generally have a plurality of still images that have to be taken and are then subsequently uploaded into an identification system.

While identification systems using Eigenfaces and Fisherfaces and other mathematical representations are known, generally these systems are not readily adaptable for identification systems to be used in conjunction with more compact devices, such as entertainment media supplying devices like television and personal computers. Generally the processing capability is too large and the systems are not readily adaptable to obtaining and continuously updating a database of known users.

Hence, there is a need for an identification system that is more readily adaptable for use with entertainment media supplying devices, such as televisions and computers. To this end, there is a need for a system that allows for rapid identification of the individual who is attempting to use the entertainment device and further allows for a continuous update of new individuals into the database for subsequent recognition.

### SUMMARY OF THE INVENTION

The aforementioned needs are satisfied by the entertainment system of the present invention which, in one embodiment, comprises an entertainment device. In one implementation the entertainment device is a television, however, it will be understood that the entertainment device can be any of a number of different entertainment devices, such as televisions, video players, monitors, personal computer systems, and the like, without departing from the spirit of the present invention. The system further includes an image capture device that is able to capture images of an individual who is utilizing the entertainment device. The entertainment capture device is associated with a processor that compares captured images of the individual sitting in front of the image capture device to stored image data in order to ascertain whether the individual using the entertainment device is a previously identified individual. If the individual is a previously identified individual, a set of entertainment preferences is recalled for this particular individual and the entertainment preferences are then used to configure the entertainment device so that the entertainment device is more reflective of the individual's preferences.

In one particular aspect, if the individual is not identified as a previously identified individual, the system will capture sufficient image data and store sufficient image data such that the individual will be identifiable the next time the individual makes use of the entertainment device. Further, the manner in which the individual makes use of the entertainment device will also be monitored so that preferences for the individual can be recorded.

In one implementation, images of individuals are captured and then processed into representative images where clustered images are averaged or otherwise combined into the representative images. The representative images are then further processed into a transform matrix with a plurality of weighting factors. Subsequent images are preferably processed so as to be comparable to the images in the transform matrix thereby simplifying the subsequent identification process.

Hence, in this implementation, an entertainment system that identifies individuals and recalls desired user parameters for the individual is disclosed which allows for more customized delivery of content to the individuals. Further, the image data is processed into a more manageable set of image data that allows for easier comparison of subsequently captured images to the pre-existing image data for identification purposes.

These and other objects and advantages of the present invention will become more apparent from the following description taken in conjunction with the accompanying drawings.

### BRIEF DESCRIPTION OF THE DRAWINGS

FIG. 1 is a simplified block diagram of an intelligent entertainment system that includes an image capture system and an image identification system;

FIG. 2 is an exemplary flow chart illustrating the operation of the system of FIG. 1 as images of a particular individual or user is captured and preferences for the individual are either developed or are extracted if the individual is recognized as a previously identified individual;

FIG. 3A is an exemplary flow diagram illustrating how input data from a video camera is used to update a database of face related data;

FIG. 3B is an exemplary flow diagram of an exemplary database having data for a variety of different faces;

FIG. 3C is an exemplary flow diagram illustrating how face data is captured and is then processed in order to obtain the information in the face database of FIG. 3B;

FIG. 4A is an exemplary flow diagram illustrating how input video from a camera is detected and then processed for subsequent analysis;

FIG. 4B is and exemplary flow diagram illustrating how detected face data is preprocessed for subsequent mathematical evaluation;

FIG. 5 is an exemplary flow diagram illustrating how face data is mathematically processed to develop representative face images for an individual;

FIG. 6 is an exemplary flow diagram where combined face images are further processed to develop mathematical weight vectors and a transfer matrix that can be used for evaluation of subsequently captured faces for identification purposes; and

FIG. 7 is an exemplary flow diagram illustrating how a subsequently acquired image is compared to previously obtained image data to determine if a user is a new user or a previous user for which desired user parameters are already known.

### DETAILED DESCRIPTION OF THE PREFERRED EMBODIMENT

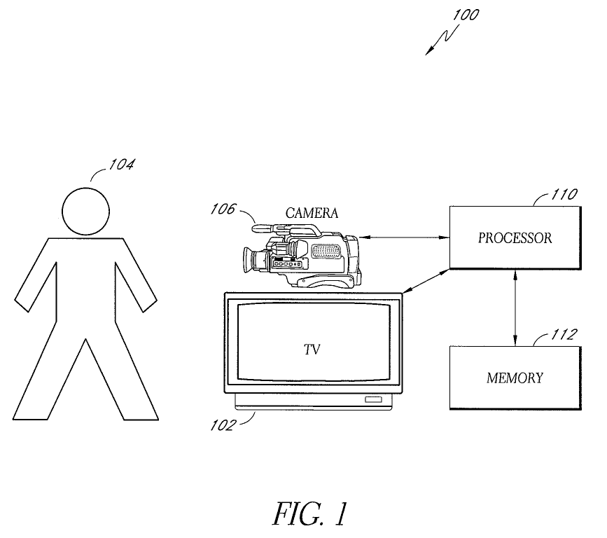

Reference will now be made wherein like numerals refer to like parts throughout. As is illustrated in FIG. 1, an exemplary entertainment system 100 includes an entertainment device 102 that one or more users 104 can utilize. The entertainment device 102 can include such things as televisions, computers, video display units and the like without departing from the spirit of the present invention. In one particular implementation, the entertainment device 102 can comprise a device that could supply all sorts of entertainment media, such as video media and audio media, on a variety of different channels. The system 100 is desirably configured to be able to recognize different users 104 so that the entertainment being provided by the entertainment device can be customized to the known preferences of a particular known user 104.

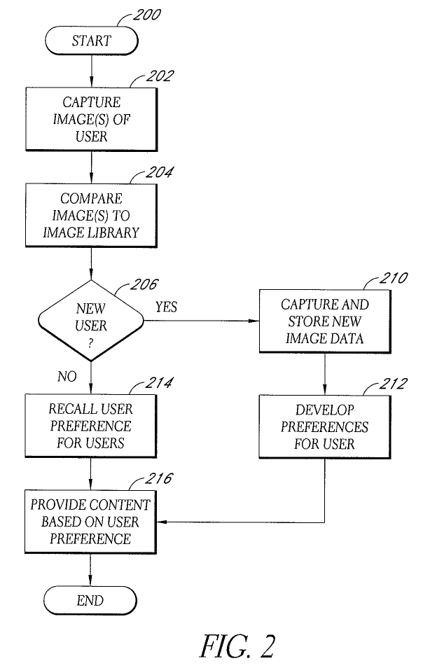

To this end, the system 100 includes an image capture device 106 that captures images of the one or more users 104 as they are positioned in front of the entertainment device 102. In one implementation, the image capture device 106 comprises a video camera that captures continuous video images of users making use of the entertainment system 100. As will be discussed in greater detail below, the captured images can be used to identify previously identified users so that entertainment preferences associated with those users can be implemented by the system 100. The captured images can further be used to capture images of new users for subsequent use in customizing the preferences for the new users. Generally, a controller, such as one or more processors or computers 110, and memories 112 are associated with the system 100 to implement the detection functionality that is described in greater detail below in conjunction with FIGS. 2-7. The processors 110 can either be part of an integrated entertainment system 100 or can be positioned remotely in any of a number of manners that are known in the art.

FIG. 2 is an exemplary flow chart which illustrates one possible method of operation of the system 100 as the system 100 is providing entertainment content to one or more users 104. The system 100 is using the camera 106 to capture an image of the users and to identify whether the user is a recognizable user and, if so, configure the entertainment system 100 so as to provide the entertainment in a manner that is more suited to the individual user's preferred preferences. It will be appreciated that the method of operation disclosed in FIG. 2 is simply exemplary and that any of a number of different methods of operation can be used to customize the entertainment system to a particular recognized individual without departing from the spirit of the present invention.

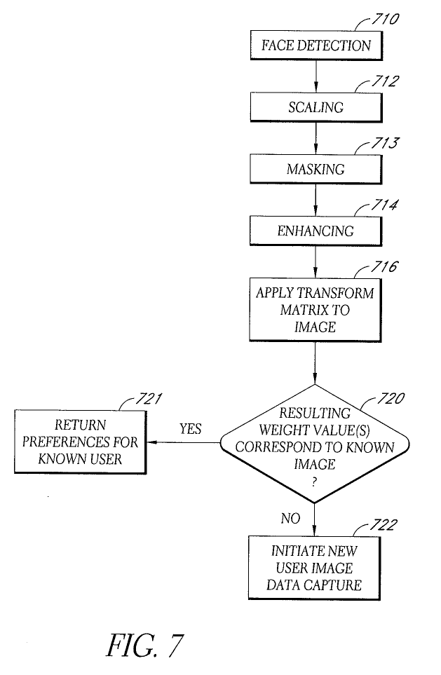

As shown in FIG. 2, from a start state 200, one or more images of the individual are captured by the camera 106. In one particular implementation, a steady stream of video images is supplied to the processors 110 from the camera 106 and these images are processed in order to identify whether a user is using the entertainment system or not. The images are processed in such a way that they can be compared, in state 204, to existing image data in an image library or data structure. Once the comparison is complete, the system 100 then determines, in decision state 206, whether the user using the entertainment system 100 is a new user or an existing user. An exemplary manner in which the determination is made as to whether an observed user is a new user or a user for which image data and preferences have been previously recorded will be described in greater detail below in conjunction with FIG. 7.

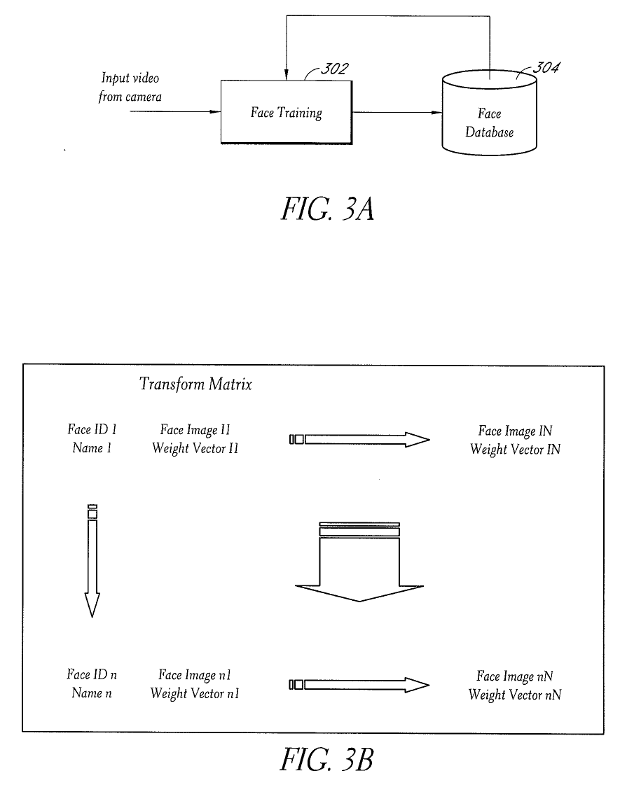

In the event that the system 100 determines that the individual is a new user, the system then begins to capture and store new image data for the new user in state 210. An exemplary process by which image data is captured and stored for particular users will be described in greater detail below in conjunction with the drawings of FIGS. 3-6.

Once image data has been accumulated for a particular individual or user, the system 100, preferably develops user parameters or preferences for the particular individual user in state 212. The user parameters can be any of a number of things such as subject matter preferences, channel preferences, visual and audio display preferences, etc. In one implementation, the system 100 will include monitors that will monitor the type of entertainment content and settings on the entertainment device 102 that a particular user prefers. These preferences will then be stored in the memory 112 in a well known fashion. Intelligent systems can be used to make predictions as to future content that a particular individual may prefer and visual and audio settings can be remembered so that when the user is subsequently identified as using the entertainment system 100, the system 100 can modify its performance settings so as to match the desired preferences.

In one specific, non-limiting example, a particular user who is interested in sporting events involving a particular team or set of teams can have preferences recorded by the system 100 such that any time the user sits down in front of the entertainment system 100 and is visually identified by the system 100, programming, such as television programming and the like, involving the set of teams or selected teams can be made available or highlighted for the user via the entertainment device 102. Similarly, particular shows or particular actors that the user displays a preference for, or particular categories of subject matter that the user has indicated a preference for by watching or hearing programming related to that subject can also be provided to the user.

It will be appreciated that any of a number of different user preferences for using the entertainment system can be recorded and processed so as to customize the content being provided to the identified user without departing from the spirit of the present invention. Individual user preferences can be identified by the system 100 as a result of observation of the user's habits in using the entertainment system 100. Further, the user may also manually provide preference information or some combination of observed, predictive or manual selection of preferences for each of the users can be implemented without departing from the spirit of the present invention.

As shown in FIG. 2, for existing users, when an existing user is identified in decision state 206, the stored user preferences for the particular individual can then be recalled in state 214 out of one or more memories 112 and the entertainment content can then be provided to the user in state 216 using the recalled user preferences.

It will be appreciated that identifying a particular user and developing data that can be used to rapidly identify particular users in an entertainment system setting can be problematic. Differences in the environment in which the entertainment system 100 is being used can result in very significant differences in the appearance of the user. Moreover, in order to provide the preferences in a timely manner, the manner in which users are identified as a previously recognized user must be quick and robust. FIGS. 3A-6 describe the systems and methods that are used in order to capture image data about particular users, process the image data in such a way that it can be used to identify whether subsequent individuals are recognized users or whether they are new users. FIG. 7 provides an illustration of system or method that can be used to identify new or recognized users based upon a comparison of a new image data to previously stored image data.

Referring specifically to FIG. 3A, for each individual user, it is necessary to capture image data about each new individual user. As shown in FIG. 3A, this is referred to as face training 302. In one particular implementation, continuous video input from the camera 106 is provided to the processor 110 and the functionality of the face training block 302 is implemented by the processor 110. In one specific implementation, when a new user is identified, the user is then asked to sit before the camera 106 and change their head pose and position and expression while looking at the camera or entertainment device 102 in a variety of different manners. Specifically, the user can be directed to change their head pose and expression while looking at the entertainment device 102 so that a variety of different images for a particular user can be obtained.

The greater the variety of images that are obtained, the more likely it is that the system 100 will be able to identify the user when the user subsequently uses the entertainment system 100. It will be appreciated that when a user is sitting in front of an entertainment device 102, such as a television, the lighting may be different, the facial expressions of the user may be different and a wide variety of other factors may be different about the subsequent appearance of the user that makes identification difficult.

In one implementation, if a user is identified by the system 100 as not recognized, the system 100 may enter a new user identification routine where the new user is prompted to move their head to various poses, change their expressions, input their name into the system 100, select preferences and the like. In another implementation, the system 100 may capture image data and preference data, without input from the user, while the user is using the entertainment system 100. Either implementation is within the scope of the present teachings.

Generally, the face training process 302 will comprise three major steps: face data preparation, wherein the captured image data is processed so as to be calibrated for subsequent comparative analysis; clustering, wherein data representative of like images are clustered together to reduce the processing needed to compare a new image to previously stored image data; and training, where data representative of the clustered images are then formed into a mathematical or logical construct that can be used for subsequent efficient comparison. Each of these steps will be described in greater detail below in conjunction with the remaining figures.

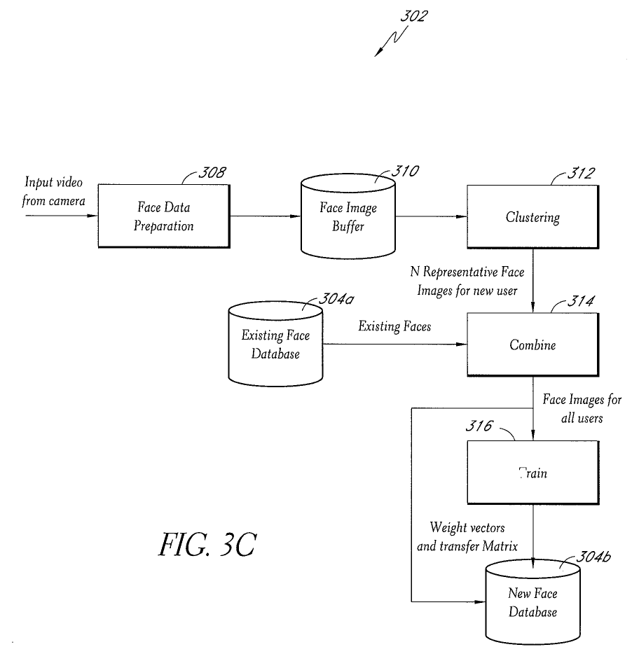

Referring specifically to FIG. 3C, the face training process 302 is described in greater detail. More specifically, as shown, the image video from the camera or other image capture device 106 (FIG. 1) is first processed in a face data preparation state 308 wherein the captured images are digitally processed to allow for subsequent mathematical processing. As will be described in FIGS. 4A and 4B, the system 100 has to detect whether a face is in the image and, if a face is in the image, the face image has to be processed, scaled and masked and enhanced, so that the resultant image data can be more readily compared to previously captured face image data in the face data base 304 (FIG. 3B). Once the face data image has been prepared in state 308, the face data image is then provided to a face image buffer 310.

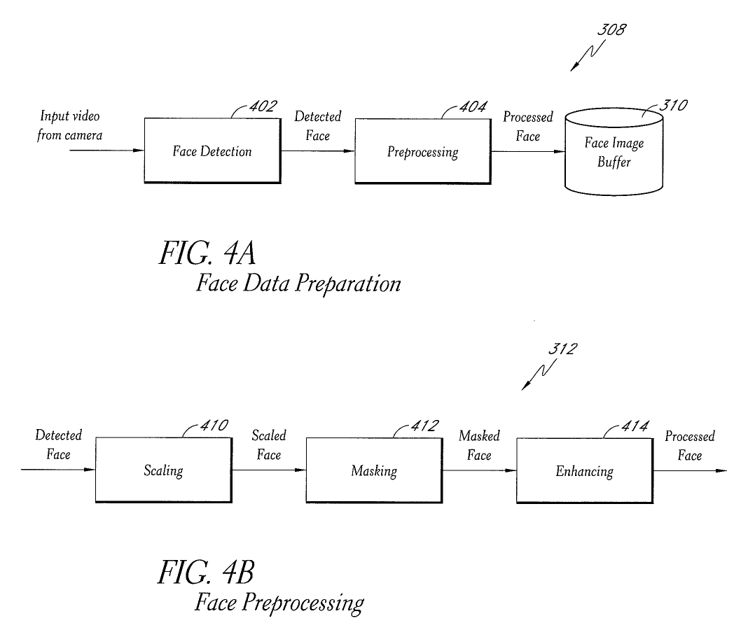

Once all of the training images have been provided to the face image buffer 310, clustering techniques are then applied in state 312 in order to obtain N representative face images of the face in the training video. Generally, the data indicative of the face images are compared using known clustering techniques and other mathematical techniques to reduce the dimensionality of the face data so that data indicative of large numbers of face images can be represented as data indicative of a smaller set of representative face images. This process will be described in greater detail in reference to FIG. 5 herein below.

Once data indicative of the N representative face images have been clustered in state 312, they are combined in state 314 with data indicative of the existing representative face images within the face database 304a such that the face database 304 is updated with the new representative face images. Subsequently, all of the stored face images in the database 304a are then trained to obtain a transform matrix and weight vector using known mathematical techniques so that mathematical tools then exist that can be used to more rapidly process subsequent images and to determine whether the subsequent images are representative of previously identified users or are new users.

The face data can be stored in the memory 112 in a format similar to that shown in FIG. 3B. In FIG. 3B, a transform matrix is disclosed which includes 1 to N face IDs with an associated name of the user. For each face ID, data indicative of a plurality of face images with an associated weight vector is attached. The face images are the representative face images captured for each user. Hence, an individual who is identified in one particular embodiment by name, which can be entered in a variety of different fashions, has a plurality of associated face images with weight vectors also associated with the face image. Hence, a plurality of representative images is used along with weighting factors in order to develop a composite image for a particular individual. In this fashion, differences in pose and lighting and other environmental factors can be accounted for in order to identify whether a new individual using the entertainment system is a previously identified user.

Referring now to FIG. 4A, the face data preparation function 308 is described in greater detail. Initially, input video from the camera 106, usually in a digital format, is provided to a face detection block 402. The face detection block 402 is identifying whether a face is positioned in front of the camera 106 indicating that a user is making use of the entertainment system 100. Face detection can be performed using any existing method and, in one particular implementation, the Viola and Jones face detection method disclosed in “Robust Real-Time Face Detection,” International Journal of Computer Vision, 57(2):137-154, 2004, by P. Viola and M. Jones, which is hereby incorporated by reference in its entirety. Once the system 100 determines that a face has been detected in block 402, the resultant image is then preprocessed in to permit subsequent analysis in block 404. The processed face image is then provided to the face image buffer 310 in the manner described previously.

As shown in FIG. 4B, the preprocessing step contains three basic steps, namely, the image is scaled, in block 410, to a standard scale size so that all of the face images are the same or comparable size to facilitate easier comparison and processing. More specifically, in the scaling block 410, the face image in the original size in the captured video is scaled into a standard size video. Subsequently, in a masking state 412, a mask is applied to the scaled image so that much of the hair, clothes, etc. of the person in the image can be removed to simplify the face detection process. In one implementation, an ellipse mask is imposed over the generally square image. The ellipse mask essentially blocks out all pixels that are outside of a generally elliptical shape wherein the elliptical shape is preferably selected to correspond to the image of a face centered in the image so that only the center facial features remain. It will be appreciated that any of a number of different masking techniques can be used to remove portions of the originally captured image that would complicate the identification assessment.

As is shown in FIG. 4B, the masked image is then enhanced in an enhancing block 414 so as to enhance the contrast of the face image such that the intensity differences between different features on the unmasked portion of the face is accentuated. In one particular implementation, a histogram equalization technique is used to enhance the contrast of all of the face images such that all processed face images have the same histogram. In one particular implementation, the method of histogram equalization is accomplished by applying a transformation function to the data such that the probability function of a particular pixel intensity is linearized across a value range.

It will be appreciated that, in essence, the raw image data is being scaled, masked and enhanced so that data indicative of a standard set of processed face images having standardized intensities can be supplied to the face image buffer 310 for subsequent combination with the existing face database in the manner that will be described in greater detail below. While histogram equalization is used to enhance the contrast of the face image, it will be appreciated that any of a number of different equalization techniques can be performed without departing from the spirit of the present invention.

As is shown in FIG. 3C, once data indicative of all of the prepared face data images are in the buffer 310, the images are then subsequently processed and clustered so as to obtain the N representative face images. Referring specifically to FIG. 5, each of the images in the face image buffer is then processed to reduce the dimensionality of the face data in block 502. In one particular implementation, principal component analysis (PCA) is used to reduce the dimensionality of the face images. In this process, face images that do not vary greatly from one another are processed so that the data indicative of the remaining images are the data indicative of those images that show the greatest variance.

Generally, in principal component analysis, the digital intensity values are transformed by an orthogonal linear transform that transforms the data to a new coordinate system such that the greatest variance by any projection of the data comes to lie on a first coordinate (called the first principal coordinate), and the second greatest variance on a second coordinate and so on, generally resulting in the data being given in least square terms. Hence, the dimensionality of the face image data is thereby reduced and the remaining face image data then is clustered in a clustering block 504. In the clustering block 504, the face image data with reduced dimensionality is clustered such that the reduced dimension dimensionality face image data are combined together into a set of N clusters. Hence, images that are similar are mathematically oriented together using a clustering technique, such as for example, hierarchical agglomerative clustering, or any other known clustering techniques. Subsequently, each of the clusters is then averaged together so that each of N clusters results in data indicative of an average representative face image.

The output from the clustering process provides data indicative of N representative face images of the new user which will be assigned a numerical ID number and the user is allowed to input a new name. The N representative face images are then transferred into the face database (See FIG. 3B) so as to update the known face images that can be used and compared to new images of faces detected of users using the entertainment system.

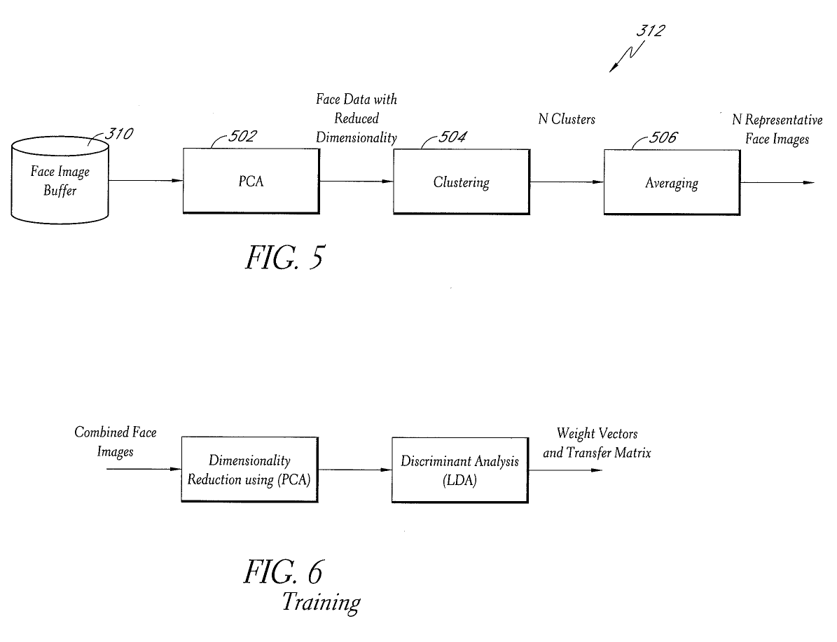

As is shown in FIG. 6, the new N representative face images along with the already existing representative face images for all other users then go through a standard PCA-LDA process to obtain a transformation matrix together with the weight vectors for each face image. More specifically, as is shown in FIG. 6, the combined representative face images from the face image database 310 is dimensionality reduced using principal component analysis (PCA) in block 602. Subsequently, the dimensionality reduced face images are then subjected to linear discriminant analysis (LDA), define the linear combination of features that best separates the images into different classes. This results in a transformation matrix of all of the images along with associated weight vectors.

These particular values can then be used to more efficiently determine whether a new image corresponds to an existing image. More specifically, as is shown in FIG. 7, when a face is detected in block 710, using essentially the same or similar process as described in block 402 in FIG. 4A, the image is then scaled in block 712 using essentially the same or similar process described in conjunction with block 404 in FIG. 4A and the scaled image is then enhanced in block 714 in essentially the same or similar process as described in conjunction with block 406 in FIG. 4A.

In this way, the new image is processed into face image data that has the same basic format and thresholds as the data that is represented in the transform matrix. The transform matrix preferably includes a plurality of weighting values W_{1 to N} for each of the representative images I_{1 to N}. So, an individual's image in the transform matrix is the weighted value of a sum of the representative images.

By applying the transform matrix to the new image in block 716, TXI_{new} should result in a plurality of weighting values W_{new}. A comparison of the W_{new} values to the existing weighting values in the transform matrix will allow a determination in decision state 720 of whether the image is an image of a user that is already recognized and stored in the transform matrix. More specifically, in one implementation, a determination of the Euclidean distance between the weights of new image W_{new} and existing weights W₁₋ₙ is performed. After this comparison, the minimum distance between the new identity and the closest associated identity can be calculated. If this minimum distance is smaller than a predefined threshold, the new image is recognized as the previously recorded associated image; otherwise, the new image is from a new user.

If the individual is identifiable, then stored preferences for the individual can be retrieved from the memory 112 (FIG. 1) and used to customize the entertainment system for the preference of the individual. If the individual is not identified, the process can proceed to state 722 where new user image data is captured in the manner described above.

Although the above-disclosed embodiments of the present teaching has shown, described and pointed out the fundamental novel features of the invention as applied to the above-disclosed embodiments, it should be understood that various omissions, substitutions and changes in the form of the details of the devices, systems, and/or methods illustrated may be made by those skilled in the art without departing from the scope of the present teachings. Consequently, the scope of the invention should not be limited to the foregoing description but should be defined by the appended claims.

What is claimed is:

1. An entertainment system comprising:
an entertainment device that provides entertainment content to one or more users;
an image capture device that captures images of one or more users;
at least one processor that sends signals to the entertainment device and receives images from the image capture device wherein the at least processor creates an image data structure that contains image data that is representative of a plurality of recognized users of the entertainment system and wherein the at least one processor further records preferences for the recognized users of the entertainment system in a preference data structure and wherein the at least one processor compares newly received images from the image capture device to the image data in the image data structure to determine if the newly received image is representative of a recognized user and, if so, the at least one processor configures the entertainment system to provide the entertainment content consistent with the preferences for the recognized user in the preference data structure.

2. The system of claim 1, wherein the at least one entertainment device comprises a video display suitable for displaying a plurality of different channels of video, wherein the preferences includes display preferences and preferences indicative of the type of video content the recognized users prefer.

3. The system of claim 1, wherein the image capture device comprises a video camera that captures a stream of images of users who are positioned so as to be using the entertainment system.

4. The system of claim 1, wherein the at least one processor includes at least one associated memory and the preference data structure and the image data structure are stored in the at least one associated memory.

5. The system of claim 1, wherein at least one processor determines whether a new user is using the entertainment system and when the at least one processor determines that a new user is using the entertainment system, the at least one processor obtains a plurality of representative images of the new user and further obtains preferences for the new user.

6. The system of claim 5, wherein the plurality of representative images are images generated from a first plurality of images obtained by the image capture devices wherein the first plurality of images are standardized and clustered to obtain the representative images.

7. The system of claim 6, wherein the first plurality of images are standardized by being scaled, masked and enhanced in a similar fashion and wherein the first plurality of images are clustered into similar images and then combined to form the representative images.

8. The system of claim 7, wherein the first plurality of images are processed using principal component analysis (PCA) to reduce the dimensionality of the first plurality of images and are then clustered using hierarchical agglomerative clustering.

9. The system of claim 7, wherein the at least one processor combines the representative images into the image data structure with pre-existing images of other recognized users and develops a transform matrix representative of all of the representative data images of the recognized users and the new user and weighting values that are used to define the contribution of the representative images that identify a particular recognized user.

10. The system of claim 9, wherein the at least one processor, upon receipt of a new image from the image capture device, processes the new image to standardized the new image to the representative images and then applies the transform matrix to the new image to determine if the new image is representative of a recognized user.

11. A system for identifying users of an entertainment system so as to be able to customize the entertainment system for identified user's preferences, the system comprising:
an image capture device that captures images of the users of the entertainment system; and
a controller that receives images from the image capture device wherein the controller creates an image data matrix that is representative of a plurality of identified users of the entertainment system wherein the controller compares newly received mages from the image capture device to image data in the image data matrix to determine if a newly received image is of a identified user or a new user and, if the image is of an identified user, the controller identifies the user so that preferences for the user can be implemented on the entertainment system and, if the image is not an identified user, the controller induces the capture of additional images of the new user so as to update the image data matrix with image data representative of the new user so that the new user is a identified user for further evaluations.

12. The system of claim 11, wherein the image capture device comprises a video camera that provides a stream of user images to the controller.

13. The system of claim 11, wherein the controller develops a plurality of representative image data elements from a plurality of images of a new user for updating the image data matrix.

14. The system of claim 13, wherein the representative image data elements are image data elements generated from a first plurality of images obtained by the image capture device wherein the first plurality of images are standardized and clustered to obtain the plurality of representative image data elements.

15. The system of claim 14, wherein the first plurality of images are standardized by being scaled, masked and enhanced in a similar fashion and wherein the first plurality of images are clustered into similar images and then combined to form the representative image data elements.

16. The system of claim 15, wherein the first plurality of images are processed using principal component analysis (PCA) to reduce the dimensionality of the first plurality of images and are then clustered using hierarchical agglomerative clustering.

17. The system of claim 15, wherein the controller updates the image data matrix by combining the representative image data elements of the new user into the image data matrix with pre-existing representative image data elements representative of other identified users and develops a transform matrix representative of all of the representative image data elements of the identified users and the new user and weighting values that are used to define the contribution of the representative images that identify a particular identified user.

18. The system of claim 17, wherein the controller develops the transform matrix by dimensionally reducing the combined image data elements using principal component analysis (PCA) on all of the combined representative image data elements in the image matrix and then performing linear discriminant analysis (LDA) to obtain the transform matrix and weighting values.

19. The system of claim 18, wherein the controller, upon receipt of a new image from the image capture device, processes the new image to standardized the new image to the representative image data elements in the image data matrix and then applies the transform matrix to the new standardized image to determine if the new image is representative of a recognized user.

20. The system of claim 19, wherein the controller determines that the new image is representative of a identified user by comparatively evaluating the resulting weighting factors to the weighting factors within the image data matrix to determine if the image corresponds to an identified user.

21. A method of modifying the operation of an entertainment system to account for the preferences of identified users, the method comprising:
determining if a user is using the entertainment system by capturing image data of the user;
determining, if a user using the entertainment system is an identified user;
updating an image data structure with image data representative of a new user so that the subsequent use of the entertainment system by the new user will result in the new user being identified;
recalling preferences for the operation of the entertainment system upon determining that an identified user is using the entertainment system; and
modifying the operation of the entertainment system to account for the preference of the identified user.

22. The system of claim 21, wherein updating an image data structure with image data elements representative of a new user comprises developing a plurality of representative image data elements from a plurality of images of the new user.

23. The system of claim 22, wherein the representative image data elements are image data elements generated from a first plurality of images obtained by the image capture device wherein the first plurality of images are standardized and clustered to obtain the plurality of representative image data elements.

24. The system of claim 23, wherein the first plurality of images are standardized by being scaled, masked and enhanced in a similar fashion and wherein the first plurality of images are clustered into similar images and then combined to form the representative images.

25. The system of claim 24, wherein the first plurality of images are processed using principal component analysis (PCA) to reduce the dimensionality of the first plurality of images and are then clustered using hierarchical agglomerative clustering.

26. The system of claim 25, wherein the image data structure is updated by combining the representative image data elements of the new user into the image data structure with pre-existing representative image data elements representative of other identified users and developing a transform matrix representative of all of the representative image data elements of the identified users and the new user and weighting values that are used to define the contribution of the representative images that identify a particular identified user.

27. The system of claim 26, wherein the transform matrix is developed by dimensionally reducing the combined image data elements using principal component analysis (PCA) on all of the combined representative image data elements in the image matrix and then performing linear discriminant analysis (LDA) to obtain the transform matrix and weighting values.

28. The system of claim 27, determining if a user using the entertainment system is an identified user comprises processing an image of the new user to standardized the image of the new user to the representative image data elements and then applying the transform matrix to the new image to determine if the new image is representative of an identified user.

29. The system of claim 28, further comprising determining that the new image is representative of a identified user by comparatively evaluating the resulting weighting factors to the weighting factors within the image data matrix to determine if the image corresponds to an identified user.
